(19) United States
(12) Patent Application Publication
(10) Pub. No.: US 2006/0118634 A1
(43) Pub. Date: Jun. 8, 2006

(54) Object with symbology

(76) Inventors: Michael M. Blythe, Albany, OR (US); Wyatt Allen Huddleston, Allen, TX (US); Matthew Ryan Bonner, Portland, OR (US); Timothy S. Hubley, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/007,984

(22) Filed: Dec. 7, 2004

(51) Int. Cl. G06K 7/10

(52) U.S. Cl. 235/462.15

(57) ABSTRACT

In one implementation, a method includes utilizing characteristic data corresponding to an object and determined using symbology on the object to perform one or more interactive tasks.

### BACKGROUND

Bar code scanners may be used to scan bar codes affixed to items of interest. The symbology used, however, may not be readily changeable without using electronic devices, such as a computer and a printer, to prepare and print a new barcode before affixing it to the item of interest. Accordingly, these implementations to modify symbology may add delay and cost.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an embodiment of an object recognition system, according to an implementation.

FIG. 2 illustrates exemplary portions of the computing device of FIG. 1, according to an implementation.

FIGS. 3A-C illustrate embodiments of symbologies in accordance with various implementations.

FIG. 4 illustrates an embodiment of a method of modifying a machine-readable symbology, according to an implementation.

FIG. 5 illustrates various components of an embodiment of a computing device which may be utilized to implement portions of the techniques discussed herein, according to an implementation.

### DETAILED DESCRIPTION

Exemplary techniques for provision and/or utilization of objects with symbologies are described. Some implementations provide efficient and/or low-cost solutions for changing the symbology without using electronic devices. The extracted characteristic data from the symbology may be utilized to perform one or more interactive tasks, such as displaying an image on a surface.

### EXEMPLARY OBJECT RECOGNITION SYSTEM

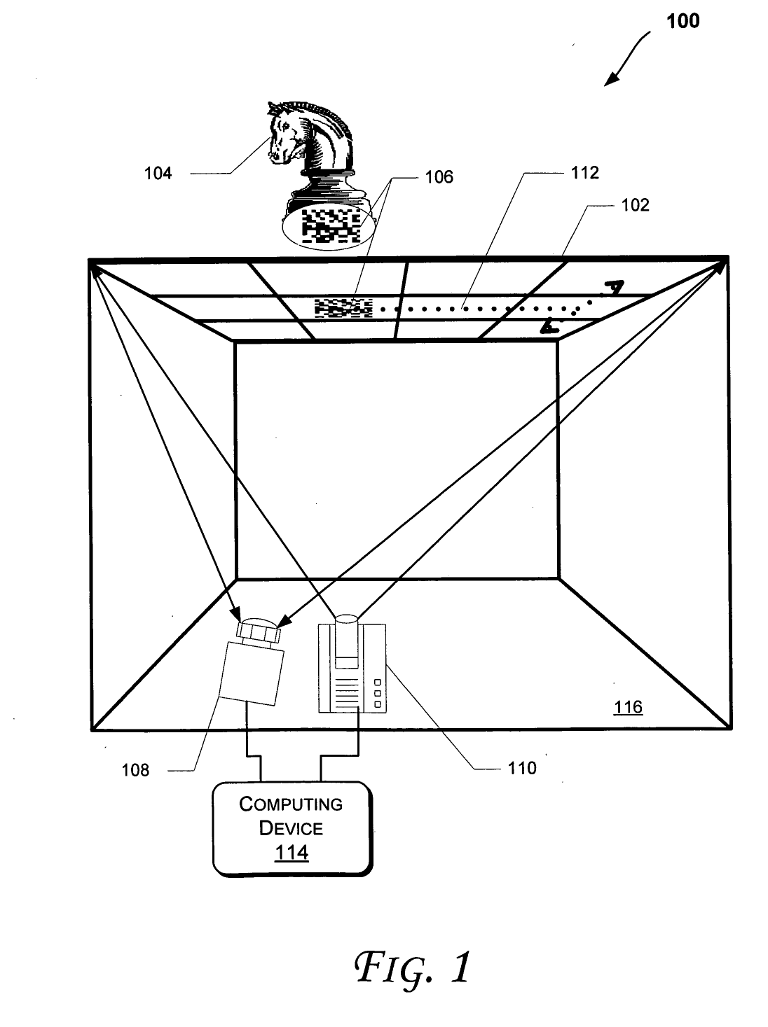

FIG. 1 illustrates an embodiment of an object recognition system 100. The system 100 includes a surface 102 which may be positioned horizontally. The surface 102 may also be tilted for viewing from the sides, for example. The system 100 recognizes an object 104 placed on the surface 102. The object 104 may be any suitable type of an object capable of being recognized such as a device, a token, a game piece, and the like.

The object 104 has a symbology 106 attached to a side of object 104, such as in one embodiment its bottom, facing surface 102 such that when the object is placed on the surface 102, a camera 108 may capture an image of the symbology 106. Accordingly, the surface 102 may be any suitable type of a translucent or semi-translucent surface (such as a projector screen) capable of supporting the object 104, while allowing electromagnetic waves to pass through the surface 102 (e.g., to enable recognition of the symbology 106 from the bottom side of the surface 102). The camera 108 may be any suitable type of capture device such as a charge-coupled device (CCD) sensor, a complementary metal oxide semiconductor (CMOS) sensor, a contact image sensor (CIS), and the like.

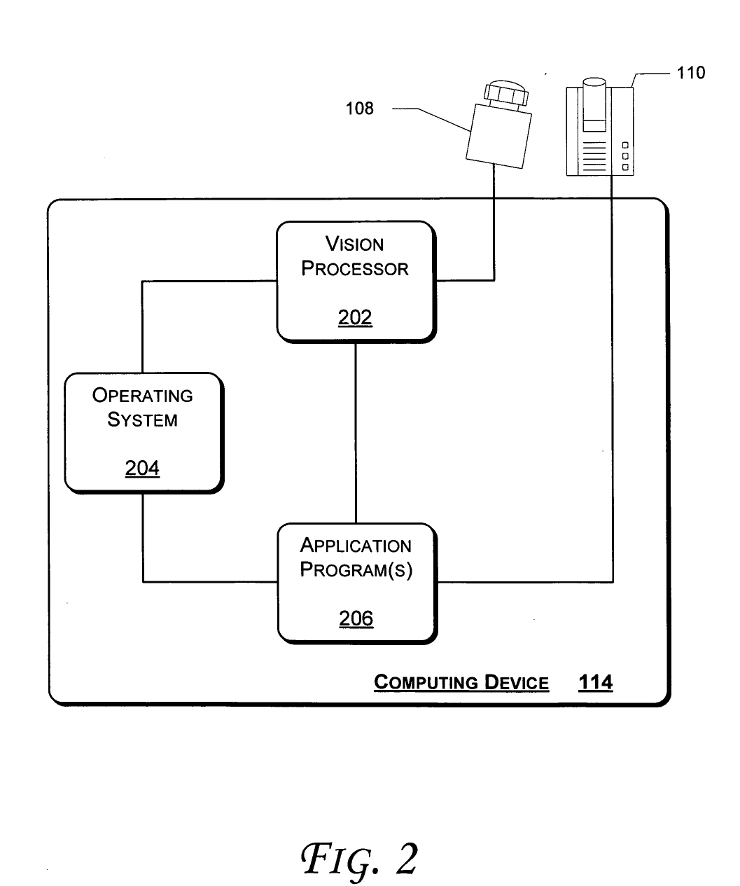

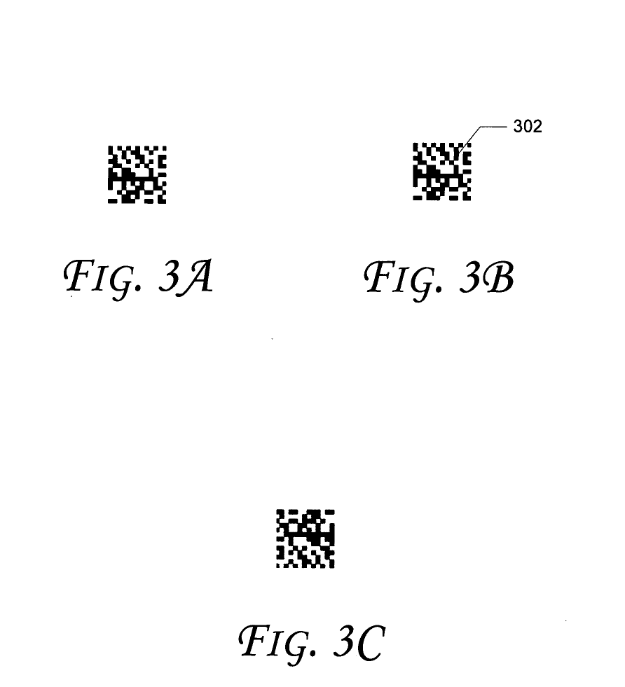

Furthermore, the symbology 106 may be any suitable type of a machine-readable symbology such as a printed label (e.g., a label printed on a laser printer, an inkjet printer, and the like), infrared (IR) reflective label, ultraviolet (UV) reflective label, and the like. By using an UV or IR illumination source (not shown) to illuminate the surface 102 from the bottom side, UV/IR filters (e.g., placed in between the illumination source and a capture device (e.g., 108 in one embodiment)), and an UV/IR sensitive camera (e.g., 108), objects (e.g., 104) on the surface 102 may be detected without utilizing complex image math. For example, when utilizing IR, tracking the IR reflection may be used for object detection, without applying image subtraction that is further discussed herein with reference to FIG. 2. It is envisioned that the illumination source may also be located on top of the surface 102 as will be further discussed with reference to FIG. 3B. Moreover, the symbology 106 may be a bar code, whether one dimensional, two dimensional, or three dimensional.

In one implementation, the system 100 determines that changes have occurred with respect to the surface 102 (e.g., the object 104 is placed or moved) by comparing a newly captured image with a reference image that may have been captured at a reference time (e.g., when no objects were present on the surface 102).

The system 100 also includes a projector 110 to project images onto the surface 102, e.g., 112 illustrating permitted moves by a chess piece, such as the illustrated knight. Accordingly, a user viewing the surface 102 from the top side may see the projected images (112). The camera 108 and the projector 110 are coupled to a computing device 114. As will be further discussed with respect to FIG. 2, the computing device 114 may control the camera 108 and/or the projector 110, e.g., to capture images of the surface 102 and project images onto the surface 102.

Additionally, as illustrated in FIG. 1, the surface 102, camera 108, and projector 110 may be part of an enclosure (116), e.g., to protect the parts from physical elements (such as dust, liquids, and the like) and/or to provide a sufficiently controlled environment for the camera 108 to be able to capture accurate images and/or for the projector to project brighter images. Also, it is envisioned that the computing device 114 (such as a laptop) may be provided wholly or partially inside the enclosure 116, or wholly external to the enclosure 116.

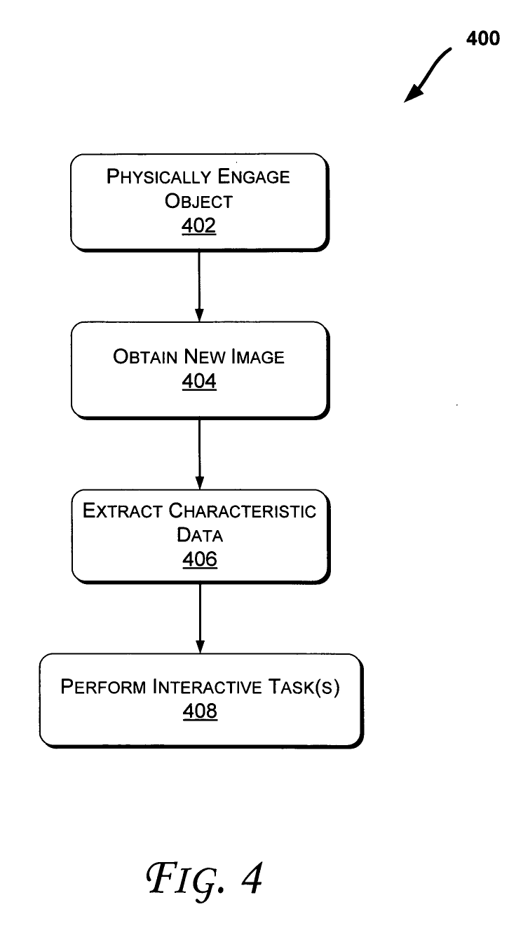

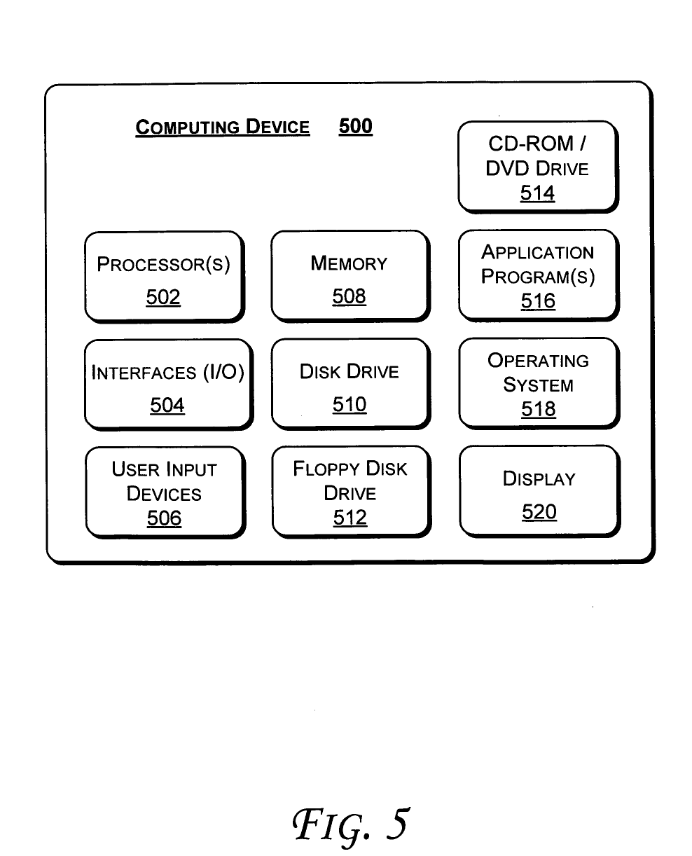

FIG. 2 illustrates exemplary portions of the computing device 114. In an implementation, the computing device 114 may be a general computing device such as 500 discussed with reference to FIG. 5. The computing device 114 includes an embodiment of a processor, such as vision processor 202, coupled to the camera 108 to determine when a change to objects (e.g., 104) on the surface 102 occurs such as a change in the number, position, and/or direction of the objects or the symbology 106 (as will be further discussed with reference to FIGS. 3 and 4). The vision processor 202 may perform an image comparison (between a reference image of the bottom side of the surface (102) and a subsequent image) to recognize that the symbology (106) has changed in value, direction, or position. Accordingly, in one embodiment, the vision processor 202 may perform a frame-to-frame image subtraction to obtain the change or delta of the surface (102).

The vision processor 202 is coupled to an operating system (O/S) 204 and one or more application programs 206. The vision processor 202 may communicate any change to the surface 102 to one or more of the O/S 204 and application programs 206. The application program(s) 206 may utilize the information regarding any changes to cause the projector 110 to project a desired image. For example, as illustrated by 112 of FIG. 1, if a knight (104) is placed on the surface 102, the application is informed of its identification (ID). If the user places a finger on the knight, the symbology is changed either electrically (via the static charge on a hand or mechanically via a button that is pressed by the player), and the projector 110 may project an image to indicate all possible, legal moves the knight is able to make on the surface 102. In another example, a “Checker” game piece may include a code on one of its sides, such as its bottom in one embodiment. When the piece is “Kinged,” an alignment/interlocking mechanism could be used to alter the code so that the application now understands that the bottom piece may move in any direction.

### EXEMPLARY OBJECT MODIFICATION

FIGS. 3A-C illustrate embodiments of symbologies. More particularly, FIG. 3A illustrates an exemplary symbology (106). FIG. 3B shows a modified version of the symbology shown in FIG. 3A. In particular, the symbology shown in FIG. 3B has been modified in the region 302. The modified symbology includes modified data which may be detected and processed as discussed with reference to FIG. 2. Further details regarding the modification of the symbology will be discussed with reference to FIG. 4. FIG. 3C illustrates the symbology 106 of FIG. 3A which has been rotated by 180 degrees. As discussed with reference to FIG. 2, the rotation of the symbology may direct the application program 206 to cause the projector 110 to project a modified image on the surface 102.

FIG. 4 illustrates an embodiment of a method, such as method 400, of modifying a machine-readable symbology. In an implementation, the system of FIG. 1 (and FIG. 2) can be utilized to perform the method 400. For example, referring to the modified symbology of FIG. 3B, it is envisioned that the symbology may be modified by physically engaging an object (e.g., 104) to modify a machine-readable symbology (e.g., 106 and 302) (402). The symbology may be on a side of the object facing surface 102, such as in one embodiment, a bottom side of the object, to allow recognition of the object from the bottom side such as discussed with reference to FIGS. 1 and 2.

The physical engagement may be accomplished by engaging one or more external items with the object (e.g., inserting one or more pins into the object, attaching a ring or other item to the object, and/or stacking a modifier object onto the object) and/or moving portions of the object to expose different symbology configurations visible from the side of the object facing surface 102. For example, the object may include horizontally rotating disk(s) that have symbology characters which may overlap differently to render a different symbology visible from the bottom side of the object. Alternatively, the object may include vertically rotating disk(s) that expose and/or hide certain symbology elements. Rotating any of these disks (regardless of the disk orientation) is envisioned to provide a different symbology to a capturing device (e.g., 108 of FIG. 1). In case of physically stacking one or more modifier objects onto the object, each higher modifier object may physically engage a lower object to modify the symbology on the side of the object facing surface 102.

In one implementation, the bottom side of the object may be semi-translucent or translucent to allow changing of the symbology exposed on the bottom side of the object through reflection of electromagnetic waves (such as IR or UV illuminations discussed with reference to FIG. 1). When a new image is of the surface (e.g., 102) is obtained (404), e.g., by the camera 108, a computing device (e.g., 114 of FIG. 2 and/or 500 of FIG. 5) may be utilized to extract characteristic data corresponding to the object from the symbology (406). The new image may be obtained as discussed with reference to FIG. 2. The extracted data may be utilized to perform one or more interactive tasks (408).

The one or more interactive tasks may include displaying an image on a surface such as discussed with reference to FIGS. 1 and 2. Also, the surface (e.g., 102 of FIG. 1) may be a computer-controlled device capable of performing one or more acts such as displaying one or more images and receiving input data. For example, the surface 102 may be a projector screen that is controlled by a computing device (e.g., 114 of FIG. 1 in one embodiment) that is capable of displaying the image 112 discussed with reference to FIG. 1. Moreover, the surface 102 may be part of a capture device (e.g., 108 of FIG. 1 in one embodiment), such as a sensor, and controlled by a computing device (e.g., 114 of FIG. 1 in one embodiment) that is capable of receiving input data (e.g., the symbology 106 of FIG. 1).

The characteristic data provided by the symbology (e.g., 106) may include one or more items such as a unique identification (ID), an application association, one or more object extents, an object mass, an application-associated capability, a sensor location, a transmitter location, a storage capacity, an object orientation, an object name, an object capability, and an object attribute. It is envisioned that the provision of the characteristic data by the symbology may enable uses without a central server connection or electronic support. For example, an object may be readily moved from one surface to another, while providing the same characteristic data to the two surfaces. The characteristic data may be encrypted in an implementation. Accordingly, the method 400 may further include decrypting the extracted characteristic prior to the utilizing act.

As discussed with reference to FIG. 2, the one or more interactive tasks may include displaying an image corresponding to a characteristic of the object and modifying a displayed image corresponding to an illustrated characteristic of the object when the illustrated characteristic changes.

### EXEMPLARY COMPUTING ENVIRONMENT

FIG. 5 illustrates various components of an embodiment of a computing device 500 which may be utilized to implement portions of the techniques discussed herein. In one implementation, the computing device 500 can be used to perform the method of FIG. 4. The computing device 500 may also be used to provide access to and/or control of the system 100, in addition to or in place of the computing device 114. The computing device 500 may further be used to manipulate, enhance, and/or store the images discussed herein. Additionally, select portions of the computing device 500 may be incorporated into a same device as the system 100 of FIG. 1.

The computing device 500 includes one or more processor(s) 502 (e.g., microprocessors, controllers, etc.), input/output interfaces 504 for the input and/or output of data, and user input devices 506. The processor(s) 502 process various instructions to control the operation of the computing device 500, while the input/output interfaces 504 provide a mechanism for the computing device 500 to communicate with other electronic and computing devices. The user input devices 506 can include a keyboard, touch screen, mouse, pointing device, and/or other mechanisms to interact with, and to input information to the computing device 500.

The computing device 500 may also include a memory 508 (such as read-only memory (ROM) and/or random-access memory (RAM)), a disk drive 510, a floppy disk drive 512, and a compact disk read-only memory (CD-ROM) and/or digital video disk (DVD) drive 514, which may provide data storage mechanisms for the computing device 500.

The computing device 500 also includes one or more application program(s) 516 (such as 206 discussed with reference to FIG. 2) and an operating system 518 (such as 204 discussed with reference to FIG. 2) which can be stored in non-volatile memory (e.g., the memory 508) and executed on the processor(s) 502 to provide a runtime environment in which the application program(s) 516 can run or execute. The computing device 500 can also include an integrated display device 520, such as for a PDA, a portable computing device, and any other mobile computing device.

Select implementations discussed herein (such as those discussed with reference to FIGS. 1-4) may include various operations. These operations may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, some implementations may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or machine-readable media suitable for storing electronic instructions and/or data. Moreover, data discussed herein may be stored in a single database, multiple databases, or otherwise in select forms (such as in a table).

Additionally, some implementations discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one implementation” or “an implementation” means that a particular feature, structure, or characteristic described in connection with the implementation is included in at least an implementation. The appearances of the phrase “in one implementation” in various places in the specification may or may not be referring to the same implementation.

Thus, although embodiments have been described in language specific to structural features and/or methodological acts, it is to be understood that claimed subject matter may not be limited to the specific features or acts described. Rather, the specific features and acts are disclosed as exemplary forms of implementing the claimed subject matter.

What is claimed is:

1. A method comprising:
utilizing characteristic data corresponding to an object and determined using symbology on the object to perform one or more interactive tasks.

2. The method of claim 1, wherein the one or more interactive tasks comprise displaying an image on a surface.

3. The method of claim 2, wherein the surface is a computer-controlled device capable of performing one or more acts selected from a group comprising displaying one or more images and receiving input data.

4. The method of claim 1, wherein the object is placed on a substantially horizontal surface.

5. The method of claim 1, wherein the characteristic data comprises one or more items selected from a group comprising a unique identification (ID), an application association, one or more object extents, an object mass, an application-associated capability, a sensor location, a transmitter location, a storage capacity, an object orientation, an object name, an object capability, and an object attribute.

6. The method of claim 1, wherein the characteristic data is encrypted.

7. The method of claim 1, wherein the one or more interactive tasks are selected from a group comprising displaying an image corresponding to a characteristic of the object and modifying a displayed image corresponding to an illustrated characteristic of the object when the illustrated characteristic changes.

8. The method of claim 1, further comprising physically engaging the object to modify the symbology.

9. The method of claim 8, wherein the engaging is performed by an act selected from a group comprising engaging one or more external items with the object and moving portions of the object to expose a different symbology configuration to a bottom side of the object.

10. The method of claim 1, further comprising physically stacking one or more modifier objects onto the object, wherein each higher modifier object physically engages a lower object to modify the symbology on a side of the object.

11. The method of claim 1, further comprises decrypting the characteristic data prior to the utilizing act.

12. The method of claim 1, wherein the object is selected from a group comprising a device, a token, and a game piece.

13. The method of claim 1, further comprising extracting the characteristic data from the symbology.

14. The method of claim 1, wherein the symbology is machine-readable.

15. An apparatus comprising:
a device to capture an image of a symbology on an object;
a processor to determine characteristic data corresponding to the object using the symbology; and
a projector to project an image, corresponding to one or more interactive tasks, onto a surface.

16. The apparatus of claim 15, wherein the one or more interactive tasks are selected using the characteristic data.

17. The apparatus of claim 15, wherein the symbology is machine-readable.

18. The apparatus of claim 15, wherein the characteristic data is extracted from the symbology.

19. The apparatus of claim 15, wherein the symbology is a machine-readable symbology selected from a group comprising a printed label, an infrared (IR) reflective label, and an ultraviolet (UV) reflective label.

20. The apparatus of claim 15, wherein the symbology is a bar code selected from a group comprising a one-dimensional, a two-dimensional, and a three-dimensional bar code.

21. The apparatus of claim 15, wherein the characteristic data comprises one or more items selected from a group comprising a unique ID, an application association, one or more object extents, an object mass, an application-associated capability, a sensor location, a transmitter location, a storage capacity, an object orientation, an object name, an object capability, and an object attribute.

22. The apparatus of claim 15, wherein the one or more interactive tasks are selected from a group comprising displaying an image on the surface corresponding to a characteristic of the object and modifying a displayed image on the surface corresponding to an illustrated characteristic of the object when the illustrated characteristic changes.

23. The apparatus of claim 15, wherein the object is physically engaged to modify the symbology.

24. The apparatus of claim 15, wherein the object is physically engaged to modify the symbology and the engaging is performed by an act selected from a group comprising engaging one or more external items with the object and moving portions of the object to expose a different symbology configuration to a bottom side of the object.

25. The apparatus of claim 15, wherein the surface is substantially horizontal.

26. The apparatus of claim 15, wherein the surface is tilted to enable viewing from sides.

27. The apparatus of claim 15, wherein the surface is one of translucent and semi-translucent.

28. The apparatus of claim 15, wherein the device is selected from a group comprising a charge-coupled device (CCD) sensor, a complementary metal oxide semiconductor (CMOS) sensor, and a contact image sensor (CIS).

29. The apparatus of claim 15, wherein the object is selected from a group comprising a device, a token, and a game piece.

30. A computer-readable medium comprising:
stored instructions to determine characteristic data corresponding to an object using a symbology on the object; and
stored instructions to utilize the characteristic data to perform one or more interactive tasks.

31. The computer-readable medium of claim 30, further comprising stored instructions to extract the characteristic data from the symbology.

32. The computer-readable medium of claim 30, wherein the symbology is machine-readable.

33. The computer-readable medium of claim 30, further comprising stored instructions to decrypt the extracted characteristic data prior to the utilizing act.

34. The computer-readable medium of claim 30, further comprising stored instructions to display an image on a surface, wherein the surface supports the object.

35. An apparatus comprising:
a surface to support an object with a symbology on the object; and
a capture device to capture an image of the symbology to extract characteristic data corresponding to the object from the symbology,
wherein an image is displayed on the surface in response to the extracted characteristic data.

36. The apparatus of claim 35, wherein the characteristic data comprises one or more items selected from a group comprising a unique ID, an application association, one or more object extents, an object mass, an application-associated capability, a sensor location, a transmitter location, a storage capacity, an object orientation, an object name, an object capability, and an object attribute.

37. The apparatus of claim 35, wherein the symbology is a machine-readable symbology.

38. The apparatus of claim 35, wherein the object is physically engaged to modify the symbology.

39. The apparatus of claim 35, wherein the displayed image is projected by a projector.

40. An apparatus comprising:
means for determining characteristic data corresponding to an object from a symbology on the object; and
means for utilizing the characteristic data to perform one or more interactive tasks.

41. The apparatus of claim 40, further comprising means for decrypting the characteristic data prior to the utilizing act.

42. The apparatus of claim 40, further comprising means for displaying an image on a surface, wherein the surface supports the object.

43. A system comprising:
a computing device;
a device coupled to the computing device to capture an image of a symbology on an object; and
a projector coupled to the computing device to project an image on the surface corresponding to one or more interactive tasks to be performed in response to characteristic data corresponding to the object.

44. The system of claim 43, wherein the characteristic data is extracted from the symbology.

45. The system of claim 43, wherein the computing device extracts the characteristic data.

46. The system of claim 43, wherein the symbology is a machine-readable symbology selected from a group comprising a printed label, an infrared (IR) reflective label, and an ultraviolet (UV) reflective label.

47. The system of claim 43, wherein the symbology is a bar code selected from a group comprising a one-dimensional, a two-dimensional, and a three-dimensional bar code.

48. The system of claim 43, wherein the characteristic data comprises one or more items selected from a group comprising a unique ID, an application association, one or more object extents, an object mass, an application-associated capability, a sensor location, a transmitter location, a storage capacity, an object orientation, an object name, an object capability, and an object attribute.

49. The system of claim 43, wherein the one or more interactive tasks are selected from a group comprising displaying an image on the surface corresponding to a characteristic of the object and modifying a displayed image on the surface corresponding to an illustrated characteristic of the object when the illustrated characteristic changes.

50. The system of claim 43, wherein the object is physically engaged to modify the symbology.

51. The system of claim 43, wherein the object is supported by a surface.

52. The system of claim 51, wherein the surface is substantially horizontal.

53. The system of claim 51, wherein the surface is tilted to enable viewing from sides.

54. The system of claim 51, wherein the surface is one of translucent and semi-translucent.

55. The system of claim 43, wherein the device is selected from a group comprising a charge-coupled device (CCD) sensor, a complementary metal oxide semiconductor (CMOS) sensor, and a contact image sensor (CIS).

56. The system of claim 43, wherein the object is selected from a group comprising a device, a token, and a game piece.

57. The system of claim 43, wherein the object is physically engaged to modify the symbology and the engaging is performed by an act selected from a group comprising engaging one or more external items with the object and moving portions of the object to expose a different symbology configuration to a bottom side of the object.
